(19) United States
(12) Patent Application Publication
(10) Pub. No.: US 2019/0037101 A1
(43) Pub. Date: Jan. 31, 2019

(54) IMAGE FORMING APPARATUS THAT CONVERTS IMAGE DATA BASED ON CONVERSION CONDITION CORRESPONDING TO TYPE OF HALFTONE PROCESS

(71) Applicant: CANON KABUSHIKI KAISHA, Tokyo (JP)

(72) Inventors: Toshiyuki Miyake, Nagareyama-shi (JP); Satoru Yamamoto, Noda-shi (JP); Katsuya Nakama, Nagareyama-shi (JP); Koji Yumoto, Toride-shi (JP); Riki Fukuhara, Funabashi-shi (JP); Akihiro Kawakita, Abiko-shi (JP)

(21) Appl. No.: 16/037,336

(22) Filed: Jul. 17, 2018

(30) Foreign Application Priority Data
Jul. 31, 2017 (JP) 2017-148200
Aug. 3, 2017 (JP) 2017-150358

(51) Int. Cl. H04N 1/405; G03G 15/01; G03G 15/00; G03G 15/16; G03G 15/20

(52) U.S. Cl. CPC H04N 1/405; G03G 15/0115; G03G 15/5016; G03G 15/2053; G03G 15/16; G03G 15/2064; G03G 15/5062

(57) ABSTRACT

An image forming apparatus, includes: a conversion unit configured to convert image data based on a conversion condition corresponding to a halftone process type; an image processing unit configured to perform a halftone process to the image data; and a controller configured to control an image forming unit to form a predetermined measurement image on an image carrier, to control the measurement unit to measure the predetermined measurement image, and to generate a predetermined conversion condition corresponding to a predetermined halftone process type based on a measurement result. In a case where the predetermined halftone process type is not performed by the image processing unit from when the predetermined measurement image is formed last time, the controller skips formation of the predetermined measurement image by the image forming unit.

### BACKGROUND OF THE INVENTION

### Field of the Invention

The present invention relates to an image forming apparatus.

### Description of the Related Art

In an image forming apparatus, a density of a formed image will vary from a target density for various reasons. Also, in an image forming apparatus that performs a plurality of halftone processes (dither processes), it is necessary to generate a tone correction condition for each halftone process, and cause the density of an image to approach the target density. In US-2012-0327480 is disclosed a configuration in which a pattern image (image for measurement) for correcting the tone correction condition for a single halftone process is formed, the density thereof is detected, and feedback for a tone correction condition of another halftone process is performed. Japanese Patent Laid-Open No. 2015-198364 discloses a configuration in which at regular intervals, a pattern image for correcting a tone correction condition of different halftone processes is formed, the density thereof is detected, and feedback for the tone correction condition is performed.

In order to obtain a stable image quality in an image forming apparatus that performs a plurality of halftone processes, it is necessary to detect the density of a pattern image formed by performing a halftone process on a correction target, and feed it back for the tone correction condition of the halftone process. Here, the halftone process that is used in actual image formation differs depending on the content of the image to be formed. For example, there are cases where images for which a low screen ruling halftone process is used are formed consecutively and cases where images for which a high screen ruling halftone process is used are formed consecutively. In a case where images for which a low screen ruling halftone process is used are formed consecutively, wasteful toner consumption results even if a pattern image is formed by performing a high screen ruling halftone process, and the high screen ruling halftone process tone correction condition is corrected.

### SUMMARY OF THE INVENTION

According to an aspect of the present invention, an image forming apparatus, includes: a conversion unit configured to convert image data based on a conversion condition corresponding to a halftone process type; an image processing unit configured to perform a halftone process to the image data converted by the conversion unit; an image forming unit configured to form an image on an image carrier based on the image data resulting from the halftone process; a transfer member at which the image is transferred from the image carrier onto a sheet; a measurement unit configured to measure a measurement image on the image carrier; and a controller configured to control the image forming unit to form a predetermined measurement image between a first image and a second image on the image carrier every time a plurality of images including the first image and the second image is formed by the image forming unit, to control the measurement unit to measure the predetermined measurement image, and to generate a predetermined conversion condition corresponding to a predetermined halftone process type based on a measurement result of the measurement unit. The first image is to be transferred onto a first sheet, the second image is to be transferred onto a second sheet, the second sheet is next to the first sheet, and in a case where the predetermined halftone process type is not performed by the image processing unit from when the predetermined measurement image is formed last time, the controller skips formation of the predetermined measurement image by the image forming unit.

Further features of the present invention will become apparent from the following description of exemplary embodiments with reference to the attached drawings.

### BRIEF DESCRIPTION OF THE DRAWINGS

FIG. 1 is a configuration diagram of an image forming apparatus.

FIG. 2 is a control configuration diagram of an image forming apparatus.

FIG. 3 is a flowchart illustrating a process for updating a tone correction condition.

FIG. 4 is a flowchart for processing for deciding a halftone process for correcting a tone correction condition.

FIGS. 5A and 5B are views for describing processing for deciding a halftone process for correcting a tone correction condition.

FIG. 6 is a flowchart for processing for deciding a halftone process for correcting a tone correction condition.

FIGS. 7A and 7B are views for describing processing for deciding a halftone process for correcting a tone correction condition.

### DESCRIPTION OF THE EMBODIMENTS

Exemplary embodiments of the present invention will be described hereinafter, with reference to the drawings. Note, the following embodiments are examples and the present invention is not limited to the content of the embodiments. Also, for the following drawings, elements that are not necessary in the explanation of the embodiment are omitted from the drawings.

### First Embodiment

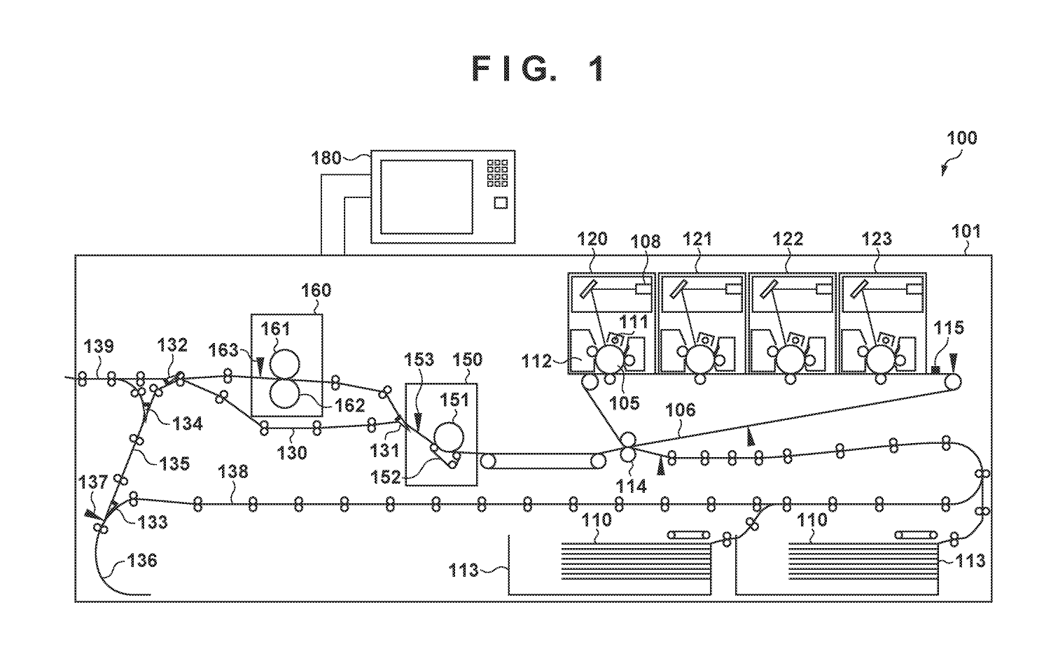

FIG. 1 is a schematic configuration diagram of an image forming apparatus 100. The image forming apparatus 100 is a laser beam printer that forms a full-color image on a sheet 110, for example. The image forming apparatus 100 comprises a printer 101 and an operation panel 180. The operation panel 180 displays a state of the image forming apparatus 100 to a user and provides an input/output interface for a user to perform input in order to operate the image forming apparatus 100.

The printer 101 has four image forming units 120-123 that form images of respective color components. The image forming unit 120 forms a yellow image, the image forming unit 121 forms a magenta image, the image forming unit 122 forms a cyan image, and the image forming unit 123 forms a black image. The configurations of each of the image forming units 120-123 are the same, and therefore description will be given below of the configuration of only the image forming unit 120 that forms yellow images. A charger 111 causes a surface of a photosensitive member 105 to be charged to a uniform potential. A laser scanner 108 emits a laser beam that is controlled based on image data onto the photosensitive member 105, and scans the photosensitive member 105 by that laser beam. Accordingly, the laser scanner 108 forms an electrostatic latent image on the photosensitive member 105. A developer 112 comprises a developing agent that comprises toner and a magnetic carrier. The developer 112 develops the electrostatic latent image on the photosensitive member 105 by using the developing agent. Thereby, the developer 112 forms a toner image on the photosensitive member 105. The toner image of the photosensitive member 105 is transferred to an intermediate transfer member 106. Note that by each of the image forming unit 120-123 transferring the toner image of the respective color overlappingly to the intermediate transfer member 106, a full-color toner image is formed on the intermediate transfer member 106.

The toner image formed on the intermediate transfer member 106 is conveyed to a position opposing a transfer roller 114 (transfer region) by rotation of the intermediate transfer member 106. Meanwhile, the sheet 110 is housed in a cassette 113. Sheets fed one at a time from the cassette 113 by a feeding mechanism are conveyed to a position facing the transfer roller 114 (transfer region) along the conveyance path. A transfer voltage is applied to the transfer roller 114. By this transfer voltage, the transfer roller 114 transfers to the sheet 110 the toner image (print image) on the intermediate transfer member 106.

The sheet 110 to which the toner image is transferred is conveyed to fixing devices 150 and 160. The fixing devices 150 and 160 heat/pressurize the toner image transferred to the sheet 110, and cause the toner image to be fixed to the sheet 110. The fixing device 150 comprises a fixing roller 151, a pressure belt 152 for causing the fixing roller 151 to press the sheet 110 and a first post-fixing sensor 153 for detecting the completion of fixation. A fixing device 160 is positioned downstream of the fixing device 150 in the direction in which the sheet 110 is conveyed. The fixing device 160 adds a gloss (sheen) to the toner image on the sheet 110 after it has passed through the fixing device 150. The fixing device 160 comprises a fixing roller 161, a pressure roller 162 for causing the fixing roller 161 to press the sheet 110 and a second post-fixing sensor 163 for detecting the completion of fixation.

In a case where an image is caused to be fixed to the sheet 110 in a mode in which gloss is added and in a case where an image is caused to be fixed to the sheet 110 for which a large amount of heat is necessary for the fixing process, the sheet 110 is conveyed to the fixing device 160 after having passed through the fixing device 150. Meanwhile, in a case where an image is caused to be fixed to thin paper, the sheet 110 is conveyed along a conveyance path 130 which bypasses the fixing device 160 after it passes through the fixing device 150. Note that an angle of a flapper 131 is controlled in order to control whether to convey the sheet 110 to the fixing device 160 or to convey the sheet 110 so as to bypass the fixing device 160.

A flapper 132 is a guiding member for switching whether to guide the sheet 110 to a conveyance path 135 or to guide it to a conveyance path 139 to the outside. The sheet 110 after being conveyed along the conveyance path 135 is conveyed to an inversion path 136. When an inversion sensor 137 located in the conveyance path 135 detects a trailing edge of the sheet 110, the conveyance direction of the sheet 110 is inverted. A flapper 133 is a guiding member for switching whether to guide the sheet 110 to a conveyance path 138 for double-sided image formation or to guide it to the conveyance path 135. In the case where a face-down mode is being executed, the sheet 110 is once again conveyed to the conveyance path 135 and discharged from the image forming apparatus 100.

Meanwhile, in a case where a double-sided print mode is executed, the sheet 110 is once again conveyed along the conveyance path 138 to the position facing the transfer roller 114 (transfer region). In a case where the double-sided print mode is executed, after an image is fixed to a first surface of the sheet 110, a switchback is performed on the sheet 110 in the inversion path 136, and it is conveyed along the conveyance path 138, and an image is formed on a second surface of the sheet 110.

A flapper 134 is a guiding member for guiding the sheet 110 to a conveyance path for discharging the sheet 110 from the image forming apparatus 100. In a case where the sheet 110 is discharged face down, the flapper 134 guides sheet after the switchback in the inversion unit 136 to the conveyance path 139 for discharging. The sheet 110, after being conveyed along the conveyance path 139 for discharging, is discharged to the outside of the image forming apparatus 100.

A density sensor 115 is an optical sensor that measures light reflected from the pattern image (measurement image) formed on the intermediate transfer member 106. The density sensor 115 is arranged at four different positions in a direction that is perpendicular to the movement direction of the surface of the intermediate transfer member 106, and each of these measures the density of the pattern image based on light reflected from the pattern image.

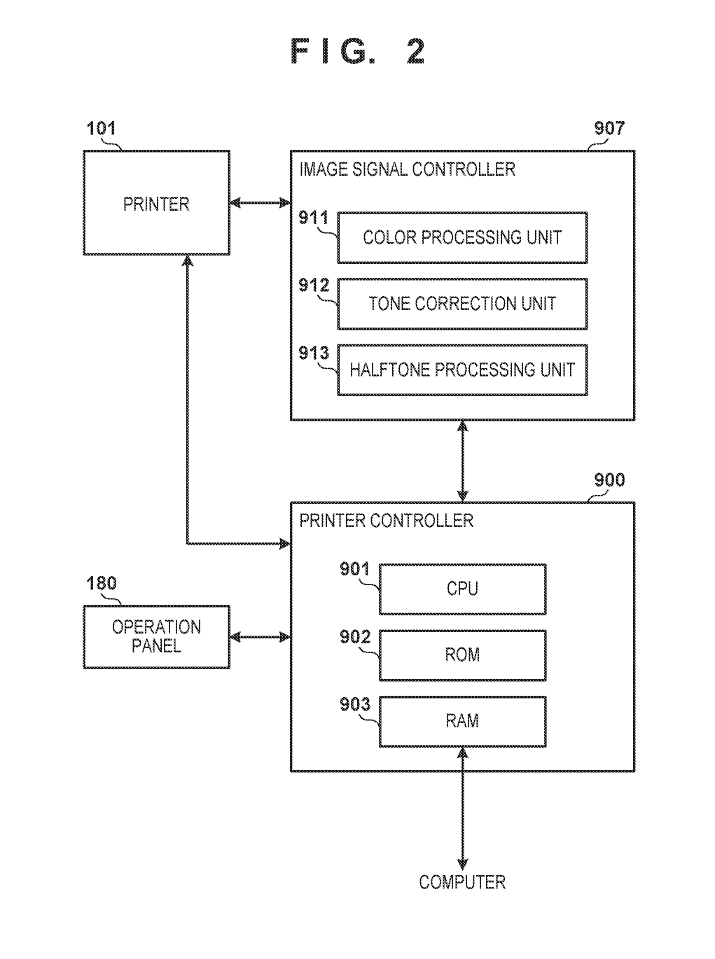

FIG. 2 illustrates a control configuration of the image forming apparatus according to this embodiment. A printer controller 900 controls the image forming apparatus 100 comprehensively. Specifically, a CPU 901 of the printer controller 900 controls the image forming apparatus 100 by executing a program stored in a ROM 902. Note that at that time the CPU 901 uses a RAM 903 as a storage region for temporary data or the like. At the time of image formation, the printer controller 900 receives digital image signals from an external computer, and outputs them to an image signal controller 907. A color processing unit 911 of the image signal controller 907 executes a color conversion on an RGB bitmap image that the inputted digital image signal indicates, and generates image data indicating an YMCK bitmap image.

A tone correction unit 912 converts input values (image signal values) of inputted image data based on a tone correction table corresponding to a halftone process type. The density of an image formed by the printer 101 does not become a desired density. Accordingly, the tone correction unit 912 converts image data input values (image signal values) such that the density of the image formed by the printer 101 is corrected to a desired density. The tone correction table functions as a conversion condition stored in a memory (not shown). Note that the tone correction table is stored for each screen described later, and is stored for each color. In the description below, the tone correction table describes a tone correction condition. Note that the tone correction unit 912 may be implemented by an integrated circuit such as an ASIC or the like, or it may be implemented by the CPU 901 converting image data based on a program stored in advance.

A halftone processing unit 913 applies halftoning (image processing) suitable for the type of image to the image data after it is converted by the tone correction unit 912. The halftone processing unit 913 converts image data based on a 190 dot screen (low screen ruling), for example, so that a photographic image or a graphic image becomes an image with superior tone characteristics. The halftone processing unit 913 converts image data based on a 230 dot screen (high screen ruling), for example, so a text image is printed sharply. The halftone processing unit 913 converts the image data based on an error diffusion method, for example, so that the high resolution image becomes an image in which moire is suppressed. Also, in a case of printing an image other than a text image of an original that a reading apparatus (not shown) read, the halftone processing unit 913 converts image data transferred from the reading apparatus based on a copier screen (copy). Then, the printer 101 forms an image based on image data after a halftone process is executed by the halftone processing unit 913. Here, the types of halftone process differ for a 190 dot screen, a 230 dot screen, and a copier screen. Note that number of types of halftone processes that can be executed on the halftone processing unit 913 is not limited to four. Also, the tone correction unit 912 and the halftone processing unit 913 may be replaced with an image processor. The image processor executes tone correction processing (transformation processing) and halftone processing on image data, and outputs the previously described image data to the printer 101.

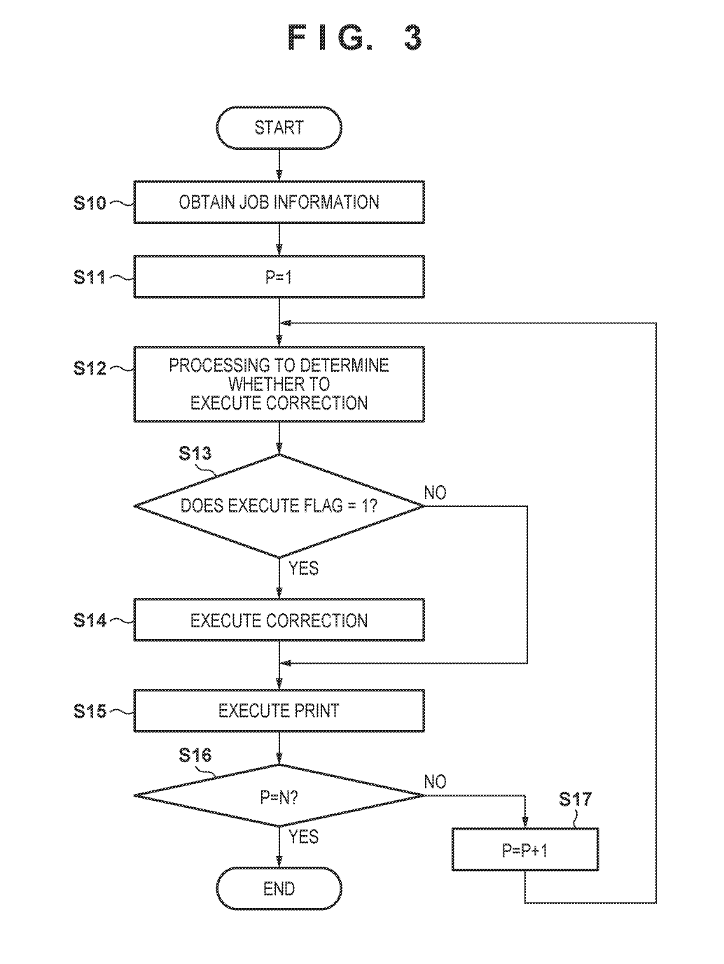

Hereinafter, control for updating a tone correction condition in the present embodiment will be described using the flowchart of FIG. 3. The image forming apparatus 100 of the present embodiment updates the tone correction condition corresponding to a 190 dot screen (low screen ruling) based on measurement results for three pattern images Pa whose tones differ. The image forming apparatus 100 of the present embodiment updates the tone correction condition corresponding to a 230 dot screen (high screen ruling) based on measurement results for three pattern images Pb whose tones differ. The image forming apparatus 100 of the present embodiment updates the tone correction condition corresponding to a copier screen (copy) based on measurement results for two pattern images Pc whose tones differ. The image forming apparatus 100 of the present embodiment updates the tone correction condition corresponding to an error diffusion method based on measurement results for two pattern images Pd whose tones differ. Since a method of updating the tone correction condition based on a small number of pattern image densities is known, detailed description thereof will be omitted. The image forming apparatus 100 of the present embodiment updates a tone correction condition corresponding to a 190 dot screen (low screen ruling) in a case where all measurement results for the pattern images Pa of three tones are obtained. The image forming apparatus 100 of the present embodiment updates a tone correction condition corresponding to a 230 dot screen (high screen ruling) in a case where all measurement results for the pattern images Pb of three tones are obtained. The image forming apparatus 100 of the present embodiment updates a tone correction condition corresponding to a copier screen (copy) in a case where all measurement results for the pattern images Pc of two tones are obtained. The image forming apparatus 100 of the present embodiment updates a tone correction condition corresponding to an error diffusion method in a case where all measurement results for the pattern images Pd of two tones are obtained.

When an instruction is made to start printing, the CPU 901, in step S10, obtains job information related to image formation that was instructed. The job information includes information indicating the number of sheets to be printed in the job and the type of halftone process to apply to the image formed on each sheet to be printed. Note that in the description below the number of sheets to be printed is N (where N is an integer greater than or equal to 1). The CPU 901, in step S11, initializes to 1 the index P which indicates the page number to be printed, and in step S12, determines whether or not to update the tone correction condition. The details of the processing in step S12 will be described later. In a case where the tone correction condition corresponding to the target halftone process is updated in the processing of step S12, the CPU 901 sets the value 1 to an execution flag, and in the case where the tone correction condition corresponding to the target halftone process is not updated, sets the value 0 to the execution flag.

The CPU 901 in step S13 determines whether or not the execution flag is 1. When the execution flag is 1 in step S13, the CPU 901, in step S14, executes the processing for correcting (updating) the tone correction condition. Specifically, the CPU 901 forms on the intermediate transfer member 106 a pattern image corresponding to the halftone process subject to correction, and detects the density of the pattern image by controlling the density sensor 115. Here, the halftone processing unit 913, in order to form a pattern image corresponding to the halftone process subject to correction, executes the halftone process subject to correction on pattern image data for forming the pattern image. The printer 101 forms a pattern image based on the measurement image data transferred from the halftone processing unit 913. Then, the CPU 901, based on the density of the pattern image detected by the density sensor 115, generates a tone correction condition corresponding to the halftone process. Here, in the case where all of the pattern images of a predetermined tone have been measured, the CPU 901 updates the tone correction condition based on a result of measuring the pattern image of a predetermined tone. For example, the CPU 901 does not update the tone correction condition corresponding to a 190 dot screen (low screen ruling) if measurement results for the pattern images Pa of three tones are not obtained. In other words, in a case where only the result of measurement of the pattern image of a single tone can be obtained, the CPU 901 moves the processing to step S15 without updating the tone correction condition. The CPU 901, after forming the pattern image corresponding to the halftone process subject to correction, forms a print image in step S15. The print image is transferred to a sheet by the transfer roller 114. Meanwhile, in a case where the execution flag is not 1 in step S13, the CPU 901 forms a print image in step S15 without executing correction of the tone correction condition. When forming of the print image that is transferred to one sheet completes, the CPU 901, in step S16, determines whether or not all of the images based on the job information have been formed. In step S16, the CPU 901 determines whether or not the value of P is the same as the number of sheets N that are printed. In the case where the value of P is less than N, the CPU 901, in step S17, increases P by 1, and transitions the processing to step S12. Meanwhile, in step S16, if the value of P is the same as the number of sheets N, the CPU 901 ends the processing.

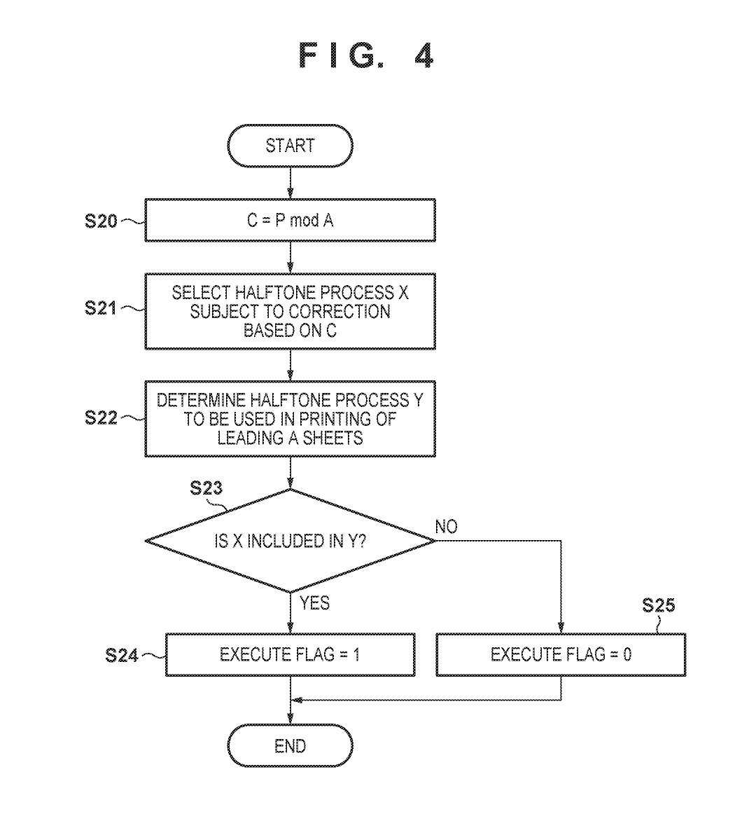

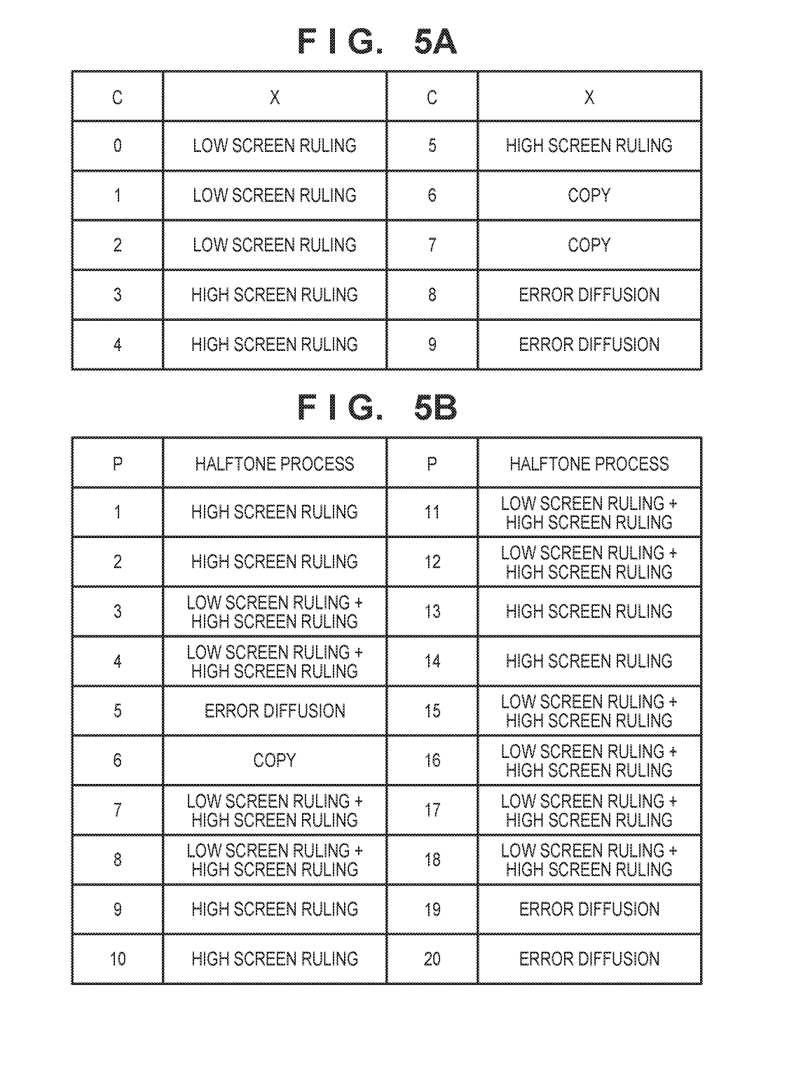

FIG. 4 is a flowchart of processing for determining whether it is necessary to execute correction in step S12 of FIG. 3. The CPU 901 corrects only one tone correction conditions in a single correction process. The CPU 901, based on the selection information stored in advance, selects the halftone process X corresponding to the tone correction condition subject to correction based on the value of P which is the page number of the sheet to be printed next. In FIG. 5A, C is a value for the remainder after the page number P was divided by a predetermined number A, and A=10 in the present embodiment. As illustrated in FIG. 5A, the selection information is information that indicates a correspondence relationship between the value C of the remainder after dividing the page number P by the predetermined number A and a halftone process subject to correction of the tone correction condition. The CPU 901 obtains the value of C in step S20, and in step S21, from the value of C and the selection information indicated in FIG. 5A, decides the halftone process X corresponding to the tone correction condition subject to correction. Subsequently, the CPU 901, in step S22, determines the halftone process to apply to the print image to be formed on the predetermined number of sheets following the page to be printed based on the job information. In the present embodiment, the predetermined number of sheets is the same as A used to obtain the value C. Accordingly, in the present embodiment, the CPU 901, in step S22, determines the halftone process to apply to the print image to be formed on a total of A sheets which are from the page P to be printed next until the page (P+A−1). Here, the set of halftone processes to be applied to the image to form on the total of A sheets is made to be Y. Note that the predetermined number of sheets may be a value that is different to A which used to obtain the value C. The CPU 901 determines in step S23 whether the halftone process X decided in step S21 is included in the set Y of halftone processes determined in step S22. When the halftone process X is included in the set Y of halftone processes, the CPU 901, in step S24, sets the value 1 to the execution flag, and when the halftone process X is not included in the set of halftone processes Y, the CPU 901, in step S25, sets the value 0 to the execution flag.

For example, configuration is such that according to the job information, the halftone process applied to the print image to be formed on the sheet of the respective page number is as in FIG. 5B. First, since C=1 when P=1, the CPU 901 in step S21 determines that the halftone process X is low screen ruling according to FIG. 5A. Next, the CPU 901, in step S22, determines the respective halftone processes for P=1 to P=10, and makes this the set Y. According to FIG. 5B, low screen ruling is included for P=3, 4, 7, and 8, and so the processing in step S23 of FIG. 4 results in Yes, and the CPU 901 sets the value 1 to the execution flag in step S24. Accordingly, in step S14 of FIG. 3, correction of the tone correction condition of the low screen ruling halftone process is executed.

Also, when P=7, C=7. Accordingly, the CPU 901, in step S21, according to FIG. 5A, determines that the halftone process X is copy. Next, the CPU 901, in step S22, determines the respective halftone processes for P=7 to 16, and makes this the set Y. According to FIG. 5B, copy is not included for P=7 to 16, and so the processing in step S23 of FIG. 4 results in No, and the CPU 901 sets the value 0 to the execution flag in step S25. Accordingly, in the determination of step S13 of FIG. 3, correction of the tone correction condition of the halftone process is executed.

In this way, in the present embodiment, before forming each print image on the intermediate transfer member 106, it is determined whether or not correction of the tone correction condition is to be performed. Here, the halftone process subject to correction of the tone correction condition is decided in advance in association with the sequence number of the sheet in the job. Then, the CPU 901, based on the halftone process to be applied to the print image to be formed on a predetermined numbers of sheets from the print image to be formed on the next sheet, decides whether or not to perform correction of the tone correction condition corresponding to the halftone process subject to correction. In the case where correction is not performed, the print image formed on the next sheet is formed on the intermediate transfer member 106 without forming the pattern image for which correction of the tone correction condition subject to correction is performed. Meanwhile, in the case of performing correction, the pattern image for which correction of the tone correction condition subject to correction is performed is formed, and correction of the tone correction condition subject to correction is performed. Then, after that, the print image to be formed on the sheet next is formed on the intermediate transfer member 106. Note that when the number from the sheet to which an image is to be printed next until the last sheet indicated in the job information is a predetermined number or more, it is decided whether or not correction of the tone correction condition subject to correction is performed based on the halftone processes to be applied to the print image to be printed on the predetermined number of sheets from the sheet on which to print next. Meanwhile, when the number from the sheet to which an image is to be printed next until the last sheet indicated in the job information is less than the predetermined number, it is decided whether or not correction of the tone correction condition subject to correction is performed based on the halftone processes to be applied to the print images to be printed on sheets from the sheet to be printed next to the last sheet. For example, assume that the predetermined number A is 10, and the number of sheets on which to print indicated in the job information is 15. In such a case, before forming an image on the first sheet, it is determined whether or not to update the tone correction condition based on the halftone processes to apply to the print image to be formed on a total of 10 sheets (from the first to the tenth sheet). Meanwhile, before forming an image on the tenth sheet, it is determined whether or not to update the tone correction condition based on the halftone processes to apply to the print image to be formed on a total of 5 sheets (from the tenth to the fifteenth sheet).

It is determined whether the halftone process subject to correction of the tone correction condition will be used in image formation to the predetermined number of sheets from the current print target, and correction of the tone correction condition is performed only in the case where it will be used. By this configuration, it is possible to prevent wasteful pattern images being formed because the frequency of formation of pattern images corresponding to a halftone process that will not be used immediately is reduced. Accordingly, it is possible to prevent wasteful toner consumption. Note that in the present embodiment, while consecutively forming a plurality of print images that are printed to sheets, it is determined whether or not correction of the tone correction condition is executed before forming a print image that is printed to a respective sheet. However, configuration may be taken to determine whether or not to execute correction of the tone correction condition every predetermined number of formations of an image to be transferred to a sheet.

### Second Embodiment

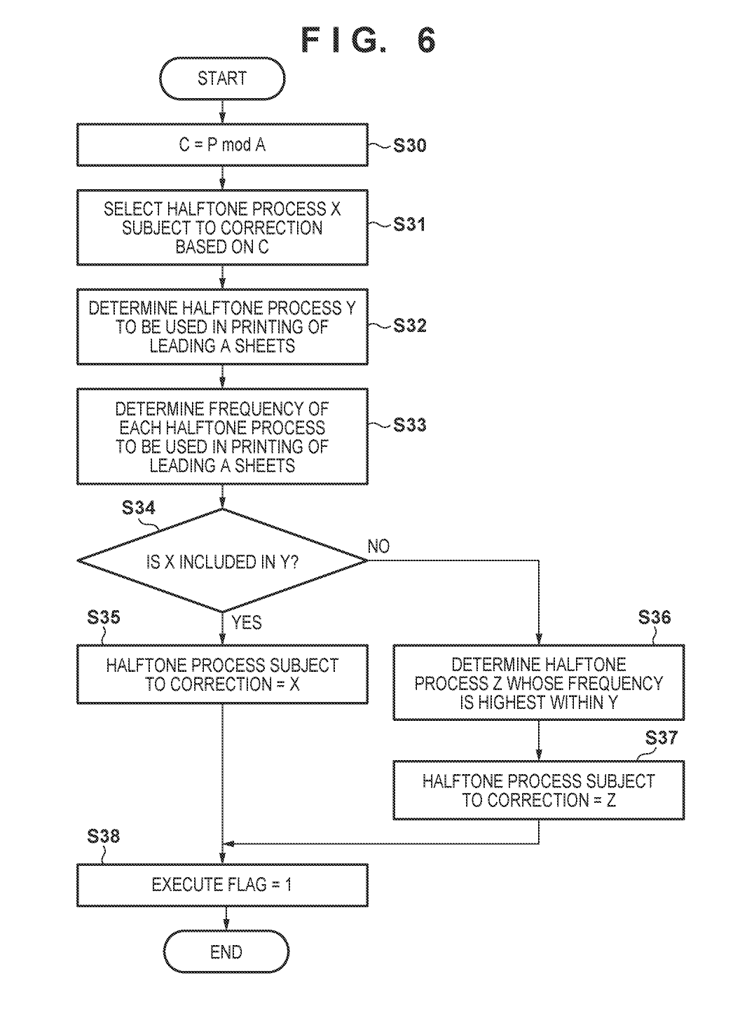

Next, description is given regarding the second embodiment focusing on points of difference with the first embodiment. In the present embodiment, the processing in step S12 of FIG. 3 differs to in the first embodiment in that the processing illustrated in FIG. 6 is performed in place of the processing of FIG. 4. The CPU 901, similarly to in the first embodiment, in step S31, based on the selection information of FIG. 5A, selects the halftone process X corresponding to the C value from among the plurality of halftone processes. Next, the CPU 901, in step S32, based on job information, determines a halftone process to apply to the print image to be formed on A sheets from the sheet to be printed, and makes the determined set of halftone processes be Y. Also, the CPU 901, in step S33, determines the frequencies of the halftone processes included in the set Y.

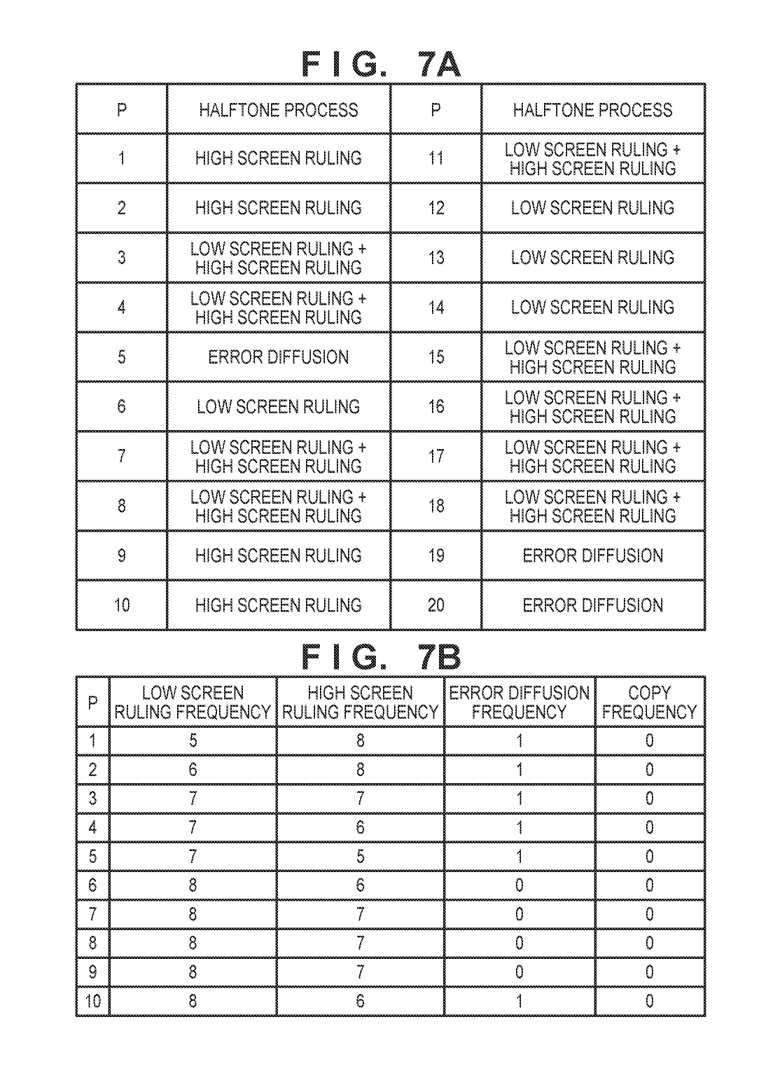

For example, assuming that, from the job information, the halftone processes to apply to images to be formed on sheets of the respective page numbers are as illustrated in FIG. 7A, the relationship between the frequency of each halftone process and the value of P is as illustrated in FIG. 7B. For example, from FIG. 7A, the numbers of low screen ruling, high screen ruling, error diffusion, and copy included in P=2 to 11 are 6, 8, 1, and 0 respectively. Accordingly, for the line P=2 in FIG. 7B, 6, 8, 1, and 0 are set respectively as the low screen ruling frequency, the high screen ruling frequency, the error diffusion frequency, and the copy frequency. The CPU 901 determines in step S31 whether the halftone process X decided in step S34 is included in the set Y of halftone processes determined in step S32. If the halftone process X included in the set Y of halftone processes, the CPU 901, in step S35, sets the halftone process corresponding to the tone correction condition subject to correction to X, and in step S38 sets the value 1 to the execution flag.

Meanwhile, when the halftone process X is not included in the set Y of halftone processes, the CPU 901 determines, in step S36, the halftone process Z with the highest frequency among the frequencies determined in step S33. Then, the CPU 901, in step S37, sets the halftone process corresponding to the tone correction condition subject to correction to Z, and in step S38 sets the value 1 to the execution flag. In other words, in the present embodiment, prior to forming a print image on the intermediate transfer memer 106, the tone correction condition correction process is always executed. However, when step S34 is Yes, the tone correction condition for the halftone process X is corrected, and when step S34 is No, the tone correction condition for the halftone process Z is corrected.

For example, since C=1 when P=1, the CPU 901 in step S31 determines that the halftone process X is low screen ruling according to FIG. 5A. Next, the CPU 901, in step S32, determines the respective halftone processes for P=1 to P=10, and makes this the set Y. According to FIG. 7A, low screen ruling is included for P=3, 4, 6, 7, and 8, and so the processing in step S34 results in Yes, and the CPU 901 sets X to the halftone process subject to correction in step S35. Accordingly, in step S14 of FIG. 3, correction of the tone correction condition of the low screen ruling halftone process is executed.

Also, since C=7 when P=7, the CPU 901 in step S31 determines that the halftone process X is copy according to FIG. 5A. Next, the CPU 901, in step S32, determines the respective halftone processes for P=7 to 16, and makes this the set Y. According to FIG. 7A, there is no copy included in P=7 to 16, and therefore the process in step S34 results in No. In such a case, the CPU 901 determines, in step S36, the halftone process with the highest frequency in the set Y. As illustrated in FIG. 7B, when P=7, the low screen ruling frequency is highest at 8. Accordingly, in step S14 of FIG. 3, correction of the tone correction condition of the low screen ruling halftone process is executed.

In the present embodiment, while a plurality of print images to be printed on sheets are being formed consecutively, the frequency of correction of the respective tone correction conditions is controlled based on the type and number of halftone processes for print images to be formed in accordance with a job. Specifically, the frequency of correction of tone correction conditions for halftone processes that are used frequently in print images to be formed in accordance with the job becomes higher. In this way, by switching the halftone process subject to correction in accordance with the frequency of use of halftone processes in print images to be formed in accordance with the job, it is possible to improve image stability of halftone processes that are used frequently. Note that the image forming apparatus of the present embodiment updates the tone correction condition corresponding to the halftone process X when the halftone process X is included in the set Y of halftone processes in step S34. However, configuration may be taken to always update the tone correction condition corresponding to the halftone process with the highest frequency among the halftone processes included in the set Y of halftone processes.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-148200, filed on Jul. 31, 2017 and Japanese Patent Application No. 2017-150358, filed on Aug. 3, 2017 which are hereby incorporated by reference herein in their entirety.

What is claimed is:

1. An image forming apparatus, comprising:
a conversion unit configured to convert image data based on a conversion condition corresponding to a halftone process type;
an image processing unit configured to perform a halftone process to the image data converted by the conversion unit;
an image forming unit configured to form an image on an image carrier based on the image data resulting from the halftone process;
a transfer member at which the image is transferred from the image carrier onto a sheet;
a measurement unit configured to measure a measurement image on the image carrier; and
a controller configured to control the image forming unit to form a predetermined measurement image between a first image and a second image on the image carrier every time a plurality of images including the first image and the second image is formed by the image forming unit, to control the measurement unit to measure the predetermined measurement image, and to generate a predetermined conversion condition corresponding to a predetermined halftone process type based on a measurement result of the measurement unit,
wherein the first image is to be transferred onto a first sheet,
wherein the second image is to be transferred onto a second sheet,
wherein the second sheet is next to the first sheet,
wherein, in a case where the predetermined halftone process type is not performed by the image processing unit from when the predetermined measurement image is formed last time, the controller skips formation of the predetermined measurement image by the image forming unit.

2. The image forming apparatus according to claim 1, wherein the controller, in a case where the predetermined halftone process type is not performed by the image processing unit to image data corresponding to images not yet formed from among the plurality of images, skips formation of the predetermined measurement image by the image forming unit.

3. An image forming apparatus, comprising:
an image processor configured to perform image processing to image data, and output the image data, the image processing including a halftone process and a tone correction process corresponding to a halftone process type;
an image forming unit configured to form an image on an image carrier based on the image data outputted by the image processor;
a transfer member at which the image is transferred from the image carrier to a sheet;
a sensor configured to measure an measurement image on the image carrier; and
a controller configured to control the image forming unit to form a first measurement image on the image carrier every time a plurality of images are formed by the image forming unit, control the sensor to measure the first measurement image, and generate a first conversion condition corresponding to a first halftone process type based on a measurement result of the first measurement image,
wherein, in a case where the first halftone process type is not performed by the image processor from when the plurality of images are formed last time, the controller controls the image forming unit to form a second measurement image without forming the first measurement image, controls the sensor to measure the second measurement image, and generates a second conversion condition corresponding to a second halftone process type different from the first halftone process type based on a measurement result of the second measurement image.

4. The image forming apparatus according to claim 3, wherein
the controller controls the image forming unit to form the first measurement image and another first measurement image on the image carrier, controls the sensor to measure the first measurement image and the other measurement image, generates the first conversion condition based on the measurement result of the first measurement image and the other first measurement image.

5. The image forming apparatus according to claim 4, wherein
the first measurement image is formed in a region between an image to be transferred to a first sheet among the plurality of sheets and another image to be transferred to a second sheet among the plurality of sheets,
the second sheet is next to the first sheet,
the other first measurement image is formed in another region between an image to be transferred to a third sheet among the plurality of sheets and another image to be transferred to a fourth sheet among the plurality of sheets,
the fourth sheet is next to the third sheet.
